(19) United States
(12) Patent Application Publication
(10) Pub. No.: US 2008/0154627 A1
(43) Pub. Date: Jun. 26, 2008

(54) Polling and Voting Methods to Reach the World-wide Audience through Creating an On-line Multi-lingual and Multi-cultural Community by Using the Internet, Cell or Mobile Phones and Regular Fixed Lines to Get People's Views on a Variety of Issues by Either Broadcasting or Narrow-casting the Issues to Particular Registered User Groups Located in Various Counrtries around the World

(75) Inventor: Ralph Liu, Norco, CA (US)

Correspondence Address: RALPH Y LIU, 1531 EL PASO DRIVE, NORCO, CA, 92860, US

(73) Assignee: Advanced e-Financial Technologies, Inc., Corona, CA (US)

(21) Appl. No.: 11/960,630

(22) Filed: Dec. 19, 2007

Related U.S. Application Data
(60) Provisional application No. 60/871,783, filed on Dec. 23, 2006.

(51) Int. Cl. G06Q 10/00

(52) U.S. Cl. 705/1

(57) ABSTRACT

An invention of a new business method as well as its associated mechanical and electronic devices for polling and voting methods to reach the world-wide audience through creating an on-line multi-lingual, multi-culture community by using the Internet, cell or mobile phones and regular fixed lines to get people's views on a variety of issues by either broadcasting or narrowcasting the issues to particular registered user groups located in various countries around the world. The verified or unverified registered users can either express their views freely on anything that could be for political, religious, philosophical, sports, entertainment, recreational, environmental, welfare, rating, popularity competition purposes or simply for compensated marketing surveys all at either a global, national, regional or local scale across different cultural, racial, religious, and geographical groups. The results will be published freely or to restricted receivers at a dedicated Internet site such as http://www.egualview.com, posted to the registered users' email addresses, cell or mobile phones, device such as i-Pods, PDAs or any other derivatives on a real time basis in multi-lingual formats to be viewed and heard by people located in different regions and countries throughout the world depending on whether it is a paid or free result. The revenue business models could be ad-based, subscription based, sponsored marketing survey based or by any other viable commercial methodologies.

A dedicated web site such as http://www.equalview.com will create new world-wide community to let people across geographical, political, religious, philosophical, cultural, racial, age, sexual preference and ethnic backgrounds to express their views on any issues that are carefully orchestrated by either broadcasting to a large group or narrow-casting to a few small selected groups in order to get the targeted results.

The members or registered users around the world in different local language web sites could elect to be verified or unverified and will voluntarily elect what kind of issues that will be broadcasted or narrow-casted to them through what mechanical or electronic means.

The views or opinions could either be voluntary and free for voting on particular global, national, regional or local issues or they could be for compensated views and opinions from marketing surveys and political focus groups purposes.

The ways of compensation for expressing views for those commercial surveys or political focus group testing purposes by members could be in real cash, credit or for an Internet version of currency to be redeemed at a local o global Internet shopping or auction website where the registered members are located depending on regulatory environment at each country or jurisdiction.

All results will be published freely or to restricted receivers at a dedicated Internet site such as http://www.equalview.com, posted to the registered users' email addresses, cell or mobile phones, device such as i-Pods, PDAs or any other derivatives on a real time basis in multi-lingual formats to be viewed and heard by people located in different regions and countries throughout the world depending on whether it is a paid or free result.

The revenue business models could be ad-based, subscription based, sponsored marketing survey based or by any other viable commercial methodologies.

The mechanical or electronic devices utilized for inputting views to the web site and to get the poll or voting and survey outputs from the web site will cover all that is currently available or in the future but they will all be converted and translated to a local language in a particular communication method that is most prevalent and popular to registered members in each country or region by using all publicly available technologies and/or proprietary methodologies.

What is claimed is:

1. A business method and process and its associated mechanical and electronic devices to create a world-wide community to allow people all over the world to express their views on anything and any issues for polling, voting and surveying purposes.

2. A world-wide and global platform or forum to let people express their views or opinions by overcoming the language, cultural, political, religious, ethnic barriers by using Internet-based and other communication technologies as well as videos, images, text, audio media marketing and facilitating methodologies.

3. Methods to generate revenues from offering such views or opinions expressing services to either smaller local groups or the world-wide audiences.
